(19) United States
(12) Patent Application Publication
(10) Pub. No.: US 2006/0046047 A1
(43) Pub. Date: Mar. 2, 2006

(54) Wiper blade for windscreen wiper and method for producing the same

(76) Inventors: Christian Wilms, Beringen (BE); Herbert Gruhn, Ludwigsburg (DE); Urich Hasenkox, Ditzingen (DE); Hellmut Schmid, Sachsenheim (DE)

Correspondence Address: KENYON & KENYON, ONE BROADWAY, NEW YORK, NY, 10004, US

(21) Appl. No.: 10/517,709

(22) PCT Filed: May 5, 2003
(86) PCT No.: PCT/DE03/01423

§ 371 Date: Jun. 9, 2005

(30) Foreign Application Priority Data
Jun. 14, 2002 (DE) 102 26 752.9

(51) Int. Cl. B60S 1/38; B32B 9/04; B32B 27/40; B32B 5/16; A47L 1/00; B05D 3/00

(52) U.S. Cl. 428/323; 15/250.48; 428/423.1; 428/447; 428/327; 427/532

(57) ABSTRACT

A wiper blade, especially for a windshield wiper, is proposed, which is provided at least from area to area with a friction-reducing coating formed by a lubricating varnish. The lubricating varnish contains a polyurethane, a siloxane and, as dry lubricant, graphite, polytetrafluoroethylene, polypropylene and/or molybdenum.

### FIELD OF THE INVENTION

The present invention relates to a wiper blade, particularly for a windshield wiper as well as a method for its manufacturing.

### BACKGROUND INFORMATION

In the case of windshield wiper blades, it is important that they are able to adapt as well as possible to the contour of the windshield of the motor vehicle and remain flexible even at different temperatures. Wiper blades are, generally, therefore produced from elastomer profiles, rubber materials, such as natural rubber or chloroprene rubber, substantially being used. In addition, wiper blades made of silicone rubber or polyurethane rubber are also conventional.

Compared to materials such as glass or plastic, elastomers have high coefficients of sliding friction so that, in the case of a specified vertical contact force of an elastomer profile in the form of a windshield wiper blade on the surface of a glass pane, a multiple of the contact force frequently has to be applied for a horizontal movement. If the windshield wiper is operated under wet conditions, this presents no substantial problems since a thin lubricating film between the windshield wiper blade and the windshield is formed by the water film on the windshield, so that hydrodynanic lubrication is established. However, problems occur when the windshield wiper blade is operated without water as a lubricating film, for example in summer or after short rain showers. Under such conditions, the windshield dries quickly, with the result that the coefficient of friction increases sharply, which may lead to squeaking, chattering or even stoppage of the windshield wiper.

Chlorination or bromination of the surface of the windshield wiper blade, i.e., curing, has frequently been carried out to date in order to reduce the coefficient of friction of windshield wiper blades on a dry glass windshield. However, this requires very exact process control and is not unproblematic in terms of aspects of environmental protection. In addition, wiping quality may be negatively influenced by such treatment methods.

Furthermore, it has been proposed to provide elastomer profiles with a coating which, in particular, reduces the coefficient of friction under dry conditions, i.e., the coefficient of dry friction μ_{dry}. Thus, Japanese Patent No. JP 55 015 873 described a wiper lip is coated with a silicone rubber into which molybdenum disulfide has been introduced as a dry lubricant for reducing the coefficient of friction. A similar approach is adopted by German Patent No. DE 38 38 904, in which a polyurethane varnish (lacquer) is used as a binder, into which graphite powder has been incorporated.

In addition, German Patent No. DE 38 39 937 Al describes a one-component polyurethane varnish which contains reactive polysiloxanes for coating elastomers. European Patent No. EP 293 084 Al describes a coating which also contains an additive, such as carbon black, Teflon, graphite or talc, in addition to a polyurethane and a siloxane. Coatings which have a low coefficient of friction under dry conditions can be produced with this material on elastomers.

### SUMMARY

An example wiper blade according to the present invention and the example methods according to the present information for manufacturing may have an advantage compared to the related art that a wiper blade is available having a coating that has an especially low coefficient of dry friction, and consequently demonstrates particularly favorable properties on dry or drying vehicle windshields.

In particular, the force necessary for moving the wiper arm over the windshield is clearly reduced by the coating according to the present invention, so that the electric motor driving the wiper arm can also be designed to be smaller. This also permits the use of more economical motors and reduces the energy consumption in the motor vehicle. The advantages named are noticeable in particular in vehicle types in which large, flat windshields, which require very long wiper arms and wiper blades, are provided for reducing the air resistance.

It is also advantageous that a reduction of unpleasant noises, such as squeaking or chattering, is achieved by the coating according to the present invention on windshield wiper blades, even under very unfavorable operating conditions, such as on a drying or a dry windshield.

A further advantage of the lubricating varnish according to the present invention and of the methods according to the present invention is that a coating produced therewith on a windshield wiper blade ensures constant good wiping quality over a longer period, in particular corresponding to the time between the normal inspection intervals of a motor vehicle.

Compared to the conventional halogenation of elastomer profiles, the example methods according to the present invention have the advantage that the applied lubricating varnish can be applied reliably with constant quality and simple process engineering. Moreover, the lubricating varnish according to the present invention is distinctly more environmentally friendly.

Thus, it is advantageous if the dry lubricant provided in the lubricating varnish has a particle size of less than 30 μm. This ensures a wiping pattern of the wiper blade that is largely free.of streaking.

It is also advantageous if the lubricating varnish according to the present invention is present in the form of an aqueous 1-component varnish which constitutes no danger to the environment. In this way, the process costs are reduced and storage is simplified.

In addition, the application of the lubricating varnish to the wiper blade is advantageously effected even before their vulcanization, so that the energy supplied during the vulcanization can simultaneously be used for curing and/or thermal crosslinking, and furthermore, the curing of the lubricating varnish takes place in a very short time. Moreover, owing to the higher reactivity of the unvulcanized materials, better crosslinking of the lubricating varnish with the elastomer of the wiper blade forming the substrate is achieved in this case.

Alternatively, however, the coating may also be applied after the vulcanization. This makes it possible to apply the varnishing of the wiper blade outside the actual production line.

### DETAILED DESCRIPTION OF EXAMPLE EMBODIMENTS

The present invention relates to a varnish sold by the firm of Henkel KGaA, Düsseldorf, under the trade name Sipiol® and intended for coating elastomers. This Sipiol® varnish, in which a polyurethane system is involved, which contains reactive polysiloxanes, is especially suitable for coating rubber profiles. In this context, the polysiloxanes crosslink with the polyurethane system so that they form a component which reduces the coefficient of friction and is integrated in the polymer. Depending on the choice of the specific Sipiol® varnish, it is initially present in the form of an aqueous 1-component varnish or a 2-component varnish and also contains carbon black and small quantitites of polytetrafluoroethylene as additives.

Specifically, customary elastomer profiles for windshield wiper blades were initially coated with a Sipiol® -based lubricating varnish in a comparative experiment. For this purpose, the varnish component Sipiol® WL 2000-21 sold by Henkel KGaA, which is present in the form of a carbon black-containing and polytetrafluoroethylene-containing suspension, was mixed in the ratio 100:6 with the isocyanate-based curing agent Wv20, likewise sold by Henkel KGBA, in accordance with instructions. This lubricating varnish was then applied in the form of a coating to the elastomer profiles which had been pretreated beforehand, to improve the adhesion, with a primer likewise sold by Henkel KGaA, under the name Cuvertin® X8536.

After the application of the lubricating varnish to the wiper blade, this was then dried for 90 minutes at 90° C., then cut, and the coefficient of dry friction against glass was then determined. This measurement still yielded relative high, unsatisfactory coefficients of dry friction in the dry state of 1.5 to 2.5. In addition, in order to check the adhesive strength of the coating produced, the wiper blade was stretched hard in the longitudinal direction. The sliding varnish adhered very well to the elastomer profile, in this context, i.e., in particular no detachment could be determined.

A second comparative experiment was based on the coating system Sipiol® WL 1000-21, which is likewise sold by Henkel KGaA and is likewise present in the form of a carbon black-containing and polytetrafluoroethylene-containing suspension, with which, however, in contrast to the Sipiol® WL 2000-21 system, no curing agent need be mixed prior to coating, i.e. it is a 1-component system. Otherwise the procedure was as before. Results obtained with the curing agent-free system Sipiol® WL 1000-21 were analogous to those obtained with the system Sipiol® WL 2000-21 laced with curing agent.

As a result of the comparative experiments, these conventional lubricating varnishes do not have sufficiently low coefficients of dry friction, but are well suitable for producing a firmly adhering coating on elastomer profiles. One of these lubricating varnishes is therefore used subsequently as a matrix system to which further dry lubricants are added, which bring on a clear reduction in the coefficient of dry friction.

In this context, it was found that graphite is especially suitable as a dry lubricant. Furthermore, adding polypropylene powder or powdered polytetrafluoroethylene or molybdenum disulfide is of advantage. In addition, two or more of the named dry lubricants may also be added to the sliding varnish, and possibly also in combination with a polyamide powder or with a polyethylene powder or a solution of a polyamide. Lubricant varnishes modified in this manner lead to very firmly adhering coatings on wiper blades having particularly low coefficients of dry friction μ_{dry} of less than 1.5, in some cases less than 1.0, which at the same time are abrasion resistant and resistant to weathering. In addition, they exhibit no transfer to the opposite body, i.e., the wiped glass. This is important especially in the case of windshields, for ensuring that no undesired greasy film which might impair the vision is left behind.

Specifically, in a first exemplary embodiment of the present invention, starting from the above-described Sipiol® WL 2000-21 system to which the isocyanate-based curing agent Wv20 was added, or alternatively starting from the curing agent-free system Sipiol® WL 1000-21, 12 g of graphite powder, having a particle size preferably less than 30 μm, was added per 50 g of curing agent-free or curing agent-containing varnish system. The suspension obtained was then thoroughly stirred and was then applied in the form of a coating to a still unvulcanized, extruded elastomer profile, which had been shaped into a windshield wiper blade. The elastomer profile was also pretreated beforehand with the primer Cuvertin® X8536, which is a solution of chlorinated polymers in organic solvents, for improving the adhesion. The application of the coating on the elastomer profile was effected by dipping, in the example described.

After application of the described lubricating varnish containing a polyurethane, a siloxane, optionally the curing agent and the graphite powder, introduced as a dry lubricant, in the form of a thin coating to the elastomer profile, drying was initially carried out for 10 minutes at 120° C. Thereafter, the coated elastomer profile was cut and the coefficient of dry friction μ_{dry}against glass was measured analogously to the comparative experiment. In this context, coefficients of dry friction which were substantially reduced compared to the latter were measured, and they were between μ_{dry} =0.65 and 1.0.

By using particularly fine graphite powder having particle sizes of, preferably, >30 μm, it is achieved that no adverse effects on the wiping pattern in the case of a wet windshield occur with the use of the coated elastomer profiles as windshield wiper blades.

The solids proportion of the added graphite powder in the lubricating varnish may be up to 75 % by weight, based on the prepared lubricating varnish suspension. It is preferably less than 25% by weight, since in some cases the coating obtained does not remain sufficiently resilient, i.e., reduced adhesion of the coating on the elastomer profile occurs.

Alternatively, polytetrafluoroethylene, molybdenum disulfide or polypropylene are also suitable as powdery dry lubricants. In this context, mixtures of graphite with an additional dry lubricant have proven particularly advantageous. Thus, graphite in combination with polytetrafluoroethylene, polyamide, polypropylene, polyethylene or molybdenum disulfide are particularly suitable. Some selected formulations are given in the following table, along with the resulting coefficients of dry friction.

| Quantity of | | | | | |
|---|---|---|---|---|---|
| Sipiol ® | Dry | Qty | Dry | Qty | |
| WL 2000-21/WL | Lubri- | in | Lubri- | in | |
| 1000-21 in grams | cant 1 | grams | cant 2 | grams | μ_{dry} |
| 50 | graphite | 12 | — | — | 0.65-1.0 |
| 50 | graphite | 16 | PTFE | 12 | 0.8-1.0 |
| 50 | graphite | 6 | PA | 6 | 1.0-1.2 |
| 50 | graphite | 6 | PE | 12 | 0.8-1.2 |

For example, a polyethylene powder sold under the name PE-UHMW Hostalen® GUR 2126 by the firm of Ticona, Oberhausen, is suitable as the polyethylene powder.

N-methoxymethylated polyamides are used as polyamide.

The Sipiol® systems mentioned are aqueous polyurethane-polysiloxane dispersions which also contain further additives. Further details on these products can be obtained from the appropriate data sheets from Henkel KGaA.

It is also possible initially to coat the elastomer profile of a wiper blade with an unmodified Sipiol® varnish system/curing agent mixture or the curing agent-free Sipiol® varnish system, i.e., without the dry lubricant, and then to apply the dry lubricant to this first coating before subsequent curing. The application of the dry lubricant can be effected, in this context, both on the already air-dried first coating or on the still-wet first coating. For this purpose, the dry lubricant is, for example, sprinkled or blown onto the still wet coating, and subsequently the coating that has powder sprinkled or blown onto it is dried for 15 min at 1200 C. Subsequent measurements of the coefficient of dry friction of coated windshield wiper blades yielded coefficients of dry friction of 0.6 to 0.9.

This procedure has the advantage that the first coating imparts, in particular, improved adhesion on the elastomer profile of the wiper blade, while the application of the dry lubricant primarily reduces the dry friction of the wiper blade relative to glass.

For the further improvement of the wiping properties of the wiper blade, a mechanical aftertreatment of the coated wiper blade may additionally be provided, for instance, by brushing.

Overall, reduced abrasion and an increased service life of the windshield wiper blade produced are achieved in this manner.

Regarding the methods for applying the coatings described to the elastomer profiles of wiper blades, and the method for their preparation or their thermal aftertreatment, it may in general also be stated that the elastomer profiles of wiper blades are produced, generally, with the aid of an extruder, the coatings according to the exemplary embodiments described being applied thereon preferably immediately after the extrusion, by spraying, dipping or brushing. After the application of the coating, a conventional vulcanization process of the elastomer profile is then carried out, for example in a salt bath or in an oven, before the coated and vulcanized elastomer profile is finally cut.

Alternatively, the application of the coating to the elastomer profile can, however, also be effected only after vulcanization, which, however, requires a further thermal treatment at, preferably, a lower temperature than that of the preceding vulcanization. This thermal treatment is then effected, for example, downstream of the salt bath or downstream of the oven in a further hot zone.

The thermal treatment during the vulcanization or in the downstream hot zone effects chemical crosslinking within the coating and also bonding or crosslinking of the coating with the elastomer profile present underneath.

Furthermore, it is possible to deliberately coat only certain surface sections of a wiper blade. Thus, by using suitable process management, by purposeful covering of areas of the wiper blade not to be coated, for instance, one may coat only the wiping strip of the wiper blade that is in contact with the surface to be cleaned, or additionally, or alternatively, a guide groove of the wiper blade by which the wiper blade is able to be introduced into a corresponding wiper blade holding device.

1-11. (canceled)

12. A wiper blade, comprising:
a blade having at least from area to area a friction-reducing coating, the coating including a lubricating varnish which includes a polyurethane and a siloxane;
wherein the coating contains, as a dry lubricant, at least one of graphite, polytetrafluoroethylene, polypropylene, and molybdenum disulfide.

13. The wiper blade according to claim 12, wherein the blade is configured for a windshield wiper.

14. The wiper blade as recited in claim 12, wherein the coating further contains at least one of polyethylene and a polyamide.

15. The wiper blade as recited in claim 12, wherein the dry lubricant has a particle size of less than 30 μm.

16. The wiper blade as recited in claim 12, wherein the coating contains at least 6% by weight of dry lubricant.

17. The wiper blade as recited in claim 12, wherein the lubricating varnish is configured to be applied to the blade as a one-component system.

18. A method for coating a wiper blade, comprising:
plasma pretreating the wiper blade; and
after the plasma pretreating, applying and curing a lubricating varnish.

19. A method for coating a wiper blade, comprising:
applying a varnish or lubricating varnish to a wiper blade; and
after applying the varnish or lubricating varnish, applying a dry lubricant to the varnish or lubricating varnish, the dry lubricant being in one of a dry form, an alcoholic solution, or an aqueous solution.

20. The method as recited in claim 19, further comprising:
before applying the dry lubricant, temperature treating the varnish or the lubricating varnish to at least one of: i) dry the varnish or lubricating varnish, and ii) thermally crosslink the varnish or the lubricating varnish.

21. The method as recited in claim 19, further comprising:
after applying the dry lubricant, temperature treating the varnished wiper blade to at least one of: i) dry the varnish or lubricating varnish, and ii) thermally crosslink the varnish or the lubricating varnish.

22. The method as recited in claim 18, further comprising:
extruding the wiper blade, wherein the varnish or the lubricating varnish and the dry lubricant is applied to the wiper blade directly after the extrusion; and
after the applying, vulcanizing the wiper blade.

23. The method as recited in claim 18, further comprising:
vulcanizing an elastomer profile wherein the varnish or the lubricating varnish and the dry lubricant are applied to the vulcanized elastomer profile.
